(19) United States
(12) Patent Application Publication
(10) Pub. No.: US 2023/0264384 A1
(43) Pub. Date: Aug. 24, 2023

(54) NOZZLE DEVICE FOR PRODUCING A THREE-DIMENSIONAL COMPONENT, AND METHOD

(71) Applicant: AEDITIVE GMBH, Norderstedt (DE)

(72) Inventors: Roman Gerbers, Hamburg (DE); Niklas NOLTE, Hamburg (DE); Hendrik LINDEMANN, Hamburg (DE)

(21) Appl. No.: 18/020,376

(22) PCT Filed: Aug. 12, 2021
(86) PCT No.: PCT/DE2021/100692

§ 371 Date: Feb. 8, 2023

(30) Foreign Application Priority Data
Aug. 13, 2020 (DE) 10 2020 121 301.8

(51) Int. Cl. B28B 1/00; B05B 15/55; B05B 15/52; B05B 7/04; B05B 7/14

(52) U.S. Cl. CPC B28B 1/001; B05B 15/55; B05B 15/52; B05B 7/0491; B05B 7/1431; B05B 7/1445; B33Y 10/00

(57) ABSTRACT

The invention relates to a nozzle device (100) for producing a three-dimensional component made of a material, in particular a shotcrete component made of concrete, a material application system (1), a manufacturing system (200) and a method for producing a three-dimensional component made of a material, in particular a shotcrete component made of concrete. In particular, the invention relates to a nozzle device (100) for producing a three-dimensional component made of a material, in particular a shotcrete component made of concrete, comprising a nozzle unit (101) with a material guide (102), which has a material inlet (104) for introducing a material, in particular a concrete, and a nozzle element (106) fluidically coupled to the material inlet (104) for applying the material, in particular the concrete, which is preferably arranged replaceably on the nozzle unit (101).

The invention relates to a nozzle device for producing a three-dimensional component from a material, in particular a shotcrete component made of concrete, a material application system, a manufacturing system and a method for producing a three-dimensional component from a material, in particular a shotcrete component made of concrete.

Nozzle devices for producing a three-dimensional component are known in principle. Nozzle devices are used to atomize materials and apply them to a substrate or material layers. The production of components with atomized material is usually used for applications in which only low requirements are placed on shape and/or position accuracy. For example, embankments are provided with shotcrete to secure them against slipping. In addition, tunnel portals are regularly formed with shotcrete. What these applications have in common, however, is that essentially no geometrically defined components or structures are created that are subject to high accuracy requirements.

In addition, known processes for atomizing a material are generally characterized by the fact that they require a high level of manual effort. The more defined the geometry to be produced with the process is to be formed, the more precisely the material must be applied.

This precise application of the material requires continuous control of the application geometry as well as continuous monitoring of the quality of the applied material. In addition, the precise application, accompanied by process interruptions and with an appropriately designed nozzle device, regularly leads to the nozzle device becoming clogged and having to be cleaned manually. Automated production of components without manual intervention is currently not possible with such nozzle devices.

Typically, it is not permissible for a shotcrete process to be interrupted during the production of a structure, as this inadmissibly reduces the quality of the component. In addition, a disadvantage of the previously known solutions is that an accelerator is merely mixed unevenly into the concrete and must therefore be dosed higher than theoretically necessary. This leads to higher component costs, increases the probability of clogging of the nozzle devices and, in the worst case, can affect the long-term strength of the component. In addition, a disadvantage of the systems used to date is that their mixers or atomization devices require a high level of additional cleaning and, moreover, there is a risk of undesirable curing occurring even during short stoppages due to the presence of the accelerator and concrete mixer.

In the case of atomization devices, there is the further disadvantage that they become clogged simply due to the high viscosity and particle sizes of the accelerators used. In addition, the prior art uses a system that has a large number of different nozzle tips with different geometries, thus enabling different application geometries. However, this reduces the flexibility and, in particular, the freedom of movement of the system. Another disadvantage of known systems is that the entire compressed air is supplied via a single mass flow controller, so that if one of the atomizer stages is clogged, the volume ratios of the compressed air of the atomizer stages change in such a way that clogging of the nozzle is favored.

The low level of automation of the process is accompanied by changes in the construction industry. Due to an increased shortage of skilled workers in the construction industry, a decline in productivity volumes can be assumed against a background of stagnating productivity. So far, only simple activities have been automated in the construction industry. In concrete construction, for example, this concerns the production of simple standardized components, such as columns or walls, which are produced in pallet circulation systems. Non-standardized components with individual dimensions, on the other hand, require a great deal of manual effort to produce the necessary formwork. Furthermore, the requirements of relevant standards must be taken into account in the production of components, especially concrete components. In addition to the high component quality to be produced for the construction industry, it must also be taken into account that there is high cost pressure in the industry.

It is therefore an objective of the invention to provide a nozzle device for producing a three-dimensional component from a material, in particular a shotcrete component made of concrete, a material application system, a manufacturing system and a method for producing a three-dimensional component from a material, in particular a shotcrete component made of concrete, which reduce or eliminate one or more of the disadvantages mentioned. In particular, it is an object of the invention to provide a solution that enables a shotcrete process to be automated.

According to a first aspect, the aforementioned objective is solved by a nozzle device for producing a three-dimensional component made of a material, in particular a shotcrete component made of concrete, comprising a nozzle unit with a material guide having a material inlet for introducing a material, in particular a concrete, and a nozzle element fluidically coupled to the material inlet for applying the material, in particular the concrete, which is arranged on the nozzle unit.

The invention is based on the realization that the automated production of a three-dimensional component from a material, in particular a shotcrete component made of concrete, is only possible if a stable process is set up and if blockages of the system, so-called nozzle cloggers, are avoided. The nozzle device for producing a three-dimensional component made of a material enables such a process to be set up and nozzle cloggers to be avoided, among other things, by the fact that the nozzle element can be cleaned and/or be replaceable at predefined time intervals and/or after a nozzle clog has been detected.

The nozzle device is configured to produce a three-dimensional component made of a material. The material may comprise or include one component or two or more components. Furthermore, the nozzle device may be configured for producing a three-dimensional component made of two or more materials. In particular, the nozzle device is configured to perform a shotcrete process or method. In particular, the two-part nozzle device with the nozzle unit and the nozzle element enables the compensation of fluctuating concrete consistency. Furthermore, a multi-stage concrete atomization with separate mass flow controllers for the compressed air and upstream atomization or nebulization of the accelerator to ensure a uniform under-mixing of the accelerator into the concrete, as will be explained in more detail below, is made possible. In addition, the concrete temperature can be actively controlled by adding tempered compressed air to compensate for temperature fluctuations.

In addition, the nozzle device enables the use of high-frequency vibrations in the nozzle unit and/or in the nozzle element to improve the spraying behavior. Furthermore, a geometry correction of the applied material layer based on robust sensor data is enabled.

The nozzle unit has the material guide with the material inlet. The material guide can be, for example, a line, a pipe, and/or a concrete hose. The material guide is preferably arranged and configured to transport, convey and/or guide concrete. The material inlet is in particular arranged and configured in such a way that the material guide can be filled with a material, in particular concrete, by means of it.

Furthermore, the nozzle device comprises the nozzle element. The nozzle element is fluidically coupled to the material inlet. Fluidically coupled means in particular that a fluid can pass from the material inlet to the nozzle element, in particular without significant losses. The fluidic coupling can take place, for example, by means of hoses, lines and/or pipes. In particular, the nozzle element is fluidically coupled to the material inlet by means of the material guide. The nozzle element preferably has a material inlet end and a spray end arranged opposite the material inlet end. The spray end is the distal end of the nozzle device. The material input end of the nozzle element is preferably configured to allow material to enter the nozzle element. The nozzle element is further preferably arranged such that the material can be moved from the material input end to the spray end. The spray end of the nozzle element is preferably configured such that this enables a shotcrete process. The nozzle element is preferably replaceably arranged on the nozzle unit. The nozzle element can, for example, be made of an elastic material, in particular an elastic plastic.

Adjacent to the spray end, the nozzle element preferably has a spray section, which can in particular have a round cross-section. Furthermore, the nozzle element and/or the spray section can be designed as a spoon nozzle, tongue nozzle, flat spray nozzle and/or slot nozzle.

Furthermore, the nozzle element is in particular arranged and configured to apply the material, in particular on a component support and/or on a material layer. The application of the material is in particular a spraying of the material.

A preferred embodiment of the nozzle device is characterized by the fact that it comprises a nozzle element interface, which is arranged and configured to form a connection between the nozzle unit and the nozzle element. The connection can, for example, be of form-fitting and/or force-fitting design. The connection is preferably a mechanical connection for forming the fluidic coupling. The nozzle element interface may comprise a centering and/or locking unit. It is furthermore preferred that the nozzle element interface is configured for automatic insertion and/or replacement of the nozzle element on the nozzle unit.

The nozzle element interface is further preferably arranged and formed in such a way that the material and preferably further substances can pass from the nozzle unit to the nozzle element. Furthermore, it is preferred that the nozzle element interface comprises a material interface, a first compressed air interface, a second compressed air interface and/or an accelerator interface.

The material interface is preferably arranged and configured in such a way that the material passes from the nozzle unit to the nozzle element. The first compressed air interface is preferably configured in such a way that compressed air at a first pressure can reach the nozzle element from the nozzle unit. The second compressed air interface is preferably configured such that compressed air at a second pressure, which is preferably different from the first pressure, can pass from the nozzle unit to the nozzle element. The accelerator interface is preferably arranged and configured to allow an accelerator to pass from the nozzle unit to the nozzle element. One or both of the compressed air interfaces may also be formed with the accelerator interface in a collective interface. In particular, it is preferred that the accelerator is mixed with compressed air upstream of the nozzle element interface so that atomization of the accelerator occurs in the nozzle unit.

Another preferred embodiment of the nozzle device is characterized by the fact that it comprises a cleaning unit that is set up to clean the nozzle unit and/or the nozzle element, in particular with a pressurized fluid, preferably water and/or air, and/or a cleaning element, in particular a cleaning pig or a cleaning ball. Furthermore, the cleaning unit can be set up to clean lines and/or supply units coupled to the nozzle device.

The cleaning unit is preferably set up to introduce a fluid into compressed air-carrying lines in order to generate the pressurized fluid. The nozzle device and the cleaning unit are in particular arranged and configured in such a way that the pressurized fluid is fed to the material guide. The cleaning element is configured in particular for cleaning, in particular for mechanical cleaning, of the material guide.

The cleaning element can preferably be inserted into the material guide with a fluid. In particular, it is preferred that after the cleaning element has been inserted into the material guide, the material guide is blown out with a fluid, in particular compressed air.

It is further preferred that the material guide and/or further hoses and/or lines have pressure sensors that are set up to compare set pressures with actual pressures. It is therefore preferred that the control device, which will be explained in more detail below, is set up to receive pressure signals from the pressure sensors and compare the actual pressures with set pressures and, if a predefined difference between the set pressure and the actual pressure is exceeded, to generate a clogging signal characterizing a clogging. The clogging signal can be received by the cleaning unit, for example, and preferably causes a cleaning process to be triggered. It is further preferred that the nozzle device comprises volume and/or mass flow sensors, wherein the control device is arranged to compare desired values of a volume and/or mass flow with actual values of the volume and/or mass flow. Furthermore, it is preferred that the nozzle device comprises fill level sensors for monitoring the fill level, in particular within the material guide. Furthermore, it is preferred that the nozzle device is arranged to monitor a cleaning condition. Preferably, the nozzle device comprises condition sensors for monitoring the cleaning condition.

In a further preferred embodiment of the nozzle device, it is provided that it comprises a blow-out unit for cleaning the nozzle device. The blow-out unit and the nozzle unit are preferably arranged such that material components which cannot be used by the nozzle unit and/or the nozzle element are disposed of by the blow-out unit. Material components that cannot be used by the nozzle unit and/or the nozzle element are, in particular, coarse material components that cannot be passed through the nozzle element. The blow-out unit preferably has a blow-out opening. The blow-out unit may, for example, be or comprise a blow-out valve, which is further preferably of a pinch valve design.

In a further preferred embodiment of the nozzle device, it is provided that it comprises a material flow control unit acting within the material guide for controlling a material flow of the material. The material flow control unit can be configured, for example, as a pinch valve. The material flow control unit is in particular arranged and configured to control, preferably initiate and/or interrupt the material flow, in particular the concrete flow. By integrating a material flow control unit into the nozzle device, the material flow is controlled, in particular initiated and/or interrupted, at a small distance from the nozzle element. In contrast to known control units in the vicinity of a concrete delivery unit, a more precise starting and stopping of the material flow can thus be made possible.

Furthermore, it is preferred that the nozzle device has a material pressure sensor, in particular a concrete pressure sensor, arranged within the material guide. The material pressure sensor is arranged and configured for monitoring set and actual pressures of the material, in particular of the concrete, in order to preferably set up a nozzle wear detection and/or a clogging detection.

In a further preferred embodiment of the nozzle device, it is provided that it comprises a sensor unit for geometry correction. The sensor unit can, for example, comprise at least one radar module or be designed as one radar module. It is particularly preferred that the sensor unit comprises two or more radar modules. The radar module is preferably arranged to detect a spacing between the nozzle device and a material layer applied with the nozzle device. A radar module can be used to detect the spacing between the nozzle device and the material layer in an advantageous manner, since a radar module does not require a clear view between the radar module and the material layer, as required by laser- or camera-based systems, for example those based on a triangulation or time-of-flight principle. The spacing preferably relates to the spacing between the nozzle element, in particular a spray end of the nozzle element, and a material layer.

Furthermore, it is preferred that the sensor unit has at least one laser measurement unit that is set up to detect a spacing between the nozzle device and a material layer applied with the nozzle device. In particular, it is preferred that the sensor unit comprises two or more laser measurement units.

Furthermore, it is preferred that the sensor unit comprises at least one profile sensor module for detecting dimensions of a material layer applied with the nozzle unit or is designed as a profile sensor module for detecting dimensions of a material layer applied with the nozzle unit. In particular, it is preferred that the sensor unit comprises two or more profile sensor modules. Preferably, the nozzle unit comprises the sensor unit, in particular the radar module and/or the profile sensor module, so that the latter is not interchanged with the nozzle element. Further preferably, a longitudinal extension of the nozzle element is taken into account when determining the spacing and/or the dimensions.

It is particularly preferred that a manufacturing system equipped with the nozzle device comprises a control system that is set up to control and/or regulate a material layer height by adjusting a nozzle feed or a robot speed and/or a material volume flow, taking into account in particular the distance between the nozzle device and the material layer determined by the sensor unit. The material volume flow can be controlled or regulated, for example, by adjusting a pump output, in particular of a concrete pump. Alternatively or additionally, the control system can also be part of the nozzle device and/or the material application system. In particular, it is preferred that the control system comprises the control device described below.

In addition, it is preferred that the control system is set up to adjust the nozzle feed as a function of the application height of the material layer detected by the sensor unit to compensate for inaccuracies between a CAD path planning and the real application process or to compensate for inaccuracies in the material feed.

In addition, it may be preferred that the control system is set up to adjust the nozzle position as a function of the dimension of the material layer detected by the sensor unit. In addition, the control system can be set up to adjust the nozzle position as a function of the distance between two adjacent material layers detected by the sensor unit, in particular to compensate for errors in a two-dimensional application.

In a further preferred embodiment of the nozzle device, it is provided that it comprises a vibration unit for introducing vibrations, which is preferably set up to introduce the vibrations into the nozzle unit and/or nozzle device. In particular, the vibration unit is configured to introduce high-frequency vibrations. For example, the vibration unit may emit ultrasound and is an ultrasonic unit. The invention is based, among other things, on the knowledge that with the introduction of vibrations, in particular ultrasonic vibrations, into the nozzle element, the application quality, in particular the spray quality, is improved and thus a more homogeneous material application is made possible and the risk of nozzle plugging is reduced.

In a further preferred embodiment of the nozzle device, it is provided that it comprises a control device. The control device is preferably arranged and configured to receive a distance signal characterizing a distance between the nozzle element and a generated material layer from the sensor unit, and/or to receive a size signal characterizing a dimension of a generated material layer from the sensor unit, and to generate a control signal for controlling a handling unit guiding the nozzle device on the basis of the distance signal and/or the size signal.

In particular, the control signal is set up to control the handling unit in such a way that a feed rate of the nozzle element is adapted. Furthermore, the control signal can alternatively or additionally control the handling unit guiding the nozzle device in such a way that a distance between the nozzle device, in particular the nozzle element, and the material layer to be produced or the produced material layer is adjusted.

Furthermore, it may be preferred that the control device is arranged and configured to receive a consistency signal characterizing a material consistency of the material and to generate and transmit a consistency correction signal. The consistency correction signal can be used, for example, to control a temperature control unit, which will be explained in more detail below, since the material consistency can be controlled by the temperature of the added compressed air.

The nozzle device preferably comprises a consistency sensor. The consistency sensor may, for example, be designed as a viscosity sensor to detect a viscosity of the material and to generate the consistency signal on this basis. Viscosity as a characteristic of consistency can in advantageously be used to determine a consistency.

A further preferred embodiment of the nozzle device provides that the control device is arranged and configured to receive a clogging signal characterizing a clogging or to detect a clogging and to initiate cleaning with a cleaning signal, in particular by means of the cleaning unit, and/or to generate a replacement signal that causes a handling unit to replace the nozzle element. In a further preferred embodiment, it is provided that the control device is arranged and configured to control a mass flow-controlled independent compressed air supply to the material atomization units explained in more detail below. This can enable constant flow conditions in the nozzle element and, as a result, constant application quality, in particular spray quality. Furthermore, this can also be made possible in the case of partially clogged atomization. In addition or alternatively, the independent compressed air supply can also be volume flow controlled.

Furthermore, the control device can be arranged and configured to initiate and/or terminate a material order by controlling the material flow control unit.

Furthermore, it is preferred that the control device is arranged and configured to receive and/or generate a wear signal and, based on the wear signal, to generate a replacement signal that causes a handling unit to replace the nozzle element. The wear signal may be generated, for example, based on a comparison of target pressures to actual pressures. The control device can be arranged and configured to generate the wear signal based on a comparison of set pressures to actual pressures.

Furthermore, it is preferred that the control device is arranged and configured to preventively detect a blockage and to initiate cleaning with a cleaning signal, in particular by means of the cleaning unit, and/or to generate a replacement signal that causes a handling unit to replace the nozzle element. The control device can be set up to detect a pressure of the compressed air at a constant compressed air volume flow and to preventively detect a blockage if a compressed air threshold value is exceeded.

Furthermore, it is preferred that the control device is arranged and configured to control a volume flow-controlled accelerator supply in order to compensate for changes in a dosed accelerator quantity due to wear on pumps or fluctuating pressure conditions. Furthermore, it is preferred that the control device controls an accelerator addition quantity in dependence of a dosed cement quantity of the concrete in order to achieve a defined ratio of cement quantity to accelerator quantity. In addition, the control device can be arranged and configured to control the ratio of cement quantity to accelerator quantity in the application process as a function of a predefined material strength, which specifies the ratio of accelerator to cement, in particular in order to adapt the application process to component requirements.

Furthermore, the control device can be arranged and configured to control the ratio of cement quantity to accelerator quantity in the application process depending on the material viscosity of the concrete in the nozzle element as detected by a viscosity sensor, in order to compensate for a fluctuating concrete viscosity. In addition, the control device can be arranged and configured to adjust the material application temperature by adding compressed air with a predefined temperature, in particular by controlling a temperature control unit. In particular, the compressed air is temperature-controlled.

In a further preferred embodiment of the nozzle device, it is provided that it comprises a first material atomization unit arranged and configured to mix and/or atomize the material with air. In particular, the first material atomization unit is configured as a first concrete atomization unit. Furthermore, the nozzle device may comprise a second material atomization unit, in particular a second concrete atomization unit, arranged and formed to mix and/or atomize the material with air and an accelerator.

It is further preferred that the nozzle element comprises the first material atomization unit and/or the second material atomization unit. For example, the material atomization units may comprise a chamber arranged and configured for the material to pass therethrough, for example with a straight direction of passage. It is further preferred that the material atomization units comprise connections for compressed air and/or the accelerator, such that the compressed air and/or the accelerator can be introduced into the chambers mentioned in the foregoing. This enables the material to be mixed and/or atomized with air or with air and the accelerator in the material atomization units.

In a further preferred embodiment of the nozzle device, it is provided that it comprises a first compressed air input, which is preferably coupled to a first pressure sensor. Furthermore, the nozzle device may comprise a second compressed air input, which is preferably coupled to a second pressure sensor. Furthermore, it may be provided that the first compressed air input and/or the first pressure sensor is/are coupled to the first material atomization unit and/or the second compressed air input and/or the second pressure sensor is/are coupled to the second material atomization unit, in particular by means of a first compressed air line and/or a second compressed air line.

The separate provision of compressed air for the first material atomization unit and the second material atomization unit enables compressed air with different parameters, in particular with different pressures or mass flows, to be provided to the first material atomization unit and the second material atomization unit. This enables constant flow conditions in the nozzle element and, as a result, constant application quality or spray quality even when the atomization unit is partially clogged. Furthermore, atomizing the concrete in two stages, i.e. in particular in the first material atomization unit and in the second material atomization unit, improves the mixing of accelerator and concrete compared to a single-stage atomization.

A further preferred embodiment of the nozzle device is characterized in that it comprises a two-substance nozzle for atomizing the accelerator with compressed air. The two-substance nozzle is preferably fluidically coupled to a compressed air inlet and an accelerator inlet, by means of which a compressed air and an accelerator can be conducted to the two-substance nozzle. This compressed air inlet is preferably coupled to a pressure regulator, which taps a compressed air from a compressed air line, which preferably leads to one of the material atomization units.

In a further preferred embodiment of the nozzle device, it is provided that it comprises a broaching unit, in particular a needle valve, which is arranged and configured to clean the two-substance nozzle by broaching material, preferably the broaching unit comprising a broach for movement into the two-substance nozzle. Furthermore, it is preferred that the two-substance nozzle is arranged upstream of the first material atomization unit and/or upstream of the second material atomization unit in the flow direction of the accelerator. This enables an atomized accelerator to be provided to the first and/or second material atomization unit. This ensures improved sub-mixing of the accelerator into the material or concrete and further improves the effectiveness of the accelerator.

In a further preferred embodiment of the nozzle device, it is provided that it comprises a temperature sensor for determining the temperature of the material, with the material guide preferably comprising the temperature sensor. Furthermore, it is preferred that the nozzle device comprises a temperature control unit for controlling the temperature of the material, in particular by heating and/or cooling a compressed air to be supplied to the material. The heated and/or cooled compressed air may, for example, be provided to the material within the first material atomization unit and/or within the second material atomization unit. It is particularly preferred that the temperature sensor is coupled to the temperature control unit and provides a temperature signal of the temperature sensor characterizing the temperature of the material, and the temperature control unit is arranged to adjust the temperature of the material and/or the compressed air based on the temperature signal.

According to a further aspect, the aforementioned objective is solved by a material application system for producing a three-dimensional component made of a material, in particular a shotcrete component made of concrete, in particular for a shotcrete process, comprising a nozzle device, in particular a nozzle device according to one of the embodiments described above, the nozzle device being coupled to a material provision unit, in particular a concrete provision unit, in such a way that material, in particular concrete, can be provided for a or the nozzle unit. In particular, the material application system is arranged to spray the material by means of a nozzle element comprised by the nozzle unit. The material supply unit is also preferably set up to supply material under pressure and/or volume flow control.

A preferred embodiment of the material application system is characterized by the fact that it comprises a cleaning device. The cleaning device is designed in particular with a cleaning section that can be inserted into the nozzle element, in particular starting from a distal end or spray end of the nozzle element. The cleaning device is arranged to loosen or remove clogging by mechanical action and/or by introduction of a fluid. The cleaning device, in particular the cleaning section, preferably comprises a fluid channel with a cleaning outlet which can be introduced into the nozzle element.

Further preferably, the cleaning section has a rod-like geometry, wherein the outer dimensions of the cleaning section for insertion into the nozzle element are configured to correspond to the inner dimensions of the nozzle element. Preferably, the outer dimensions of the cleaning section are less than the inner dimensions of the nozzle element, wherein preferably a size ratio of one of the inner dimensions to one of the outer dimensions is less than 95%, less than 90%, less than 80%, or less than 50%. It is further preferred that the size ratio is greater than 10%, greater than 20%, or greater than 30%. Preferably, the cleaning device, in particular the cleaning section, is formed as or comprises a fluid-carrying cleaning lance.

The cleaning device may be stationary so that the nozzle element is moved to the cleaning device to perform cleaning. For example, the nozzle element may be moved to the cleaning device such that an opening axis of the nozzle element and a cleaning axis of the cleaning section are substantially coaxially aligned. Then, an axial movement of the nozzle element toward the cleaning device may be performed to introduce the cleaning section into the nozzle element so that mechanical cleaning is performed. Furthermore, a fluid flow from the cleaning outlet can be affected so that the nozzle element is fluidically cleaned.

In a further preferred embodiment of the material application system, it is provided that it has a nozzle element deposit for nozzle elements. The nozzle element holder is used to store the nozzle elements that are not in use.

Furthermore, it is preferred that the material application system comprises a first fluid supply unit, in particular a compressed air supply unit, which is coupled to the nozzle device in such a way that a first fluid, preferably air, in particular compressed air, can be provided to the nozzle device.

In a further preferred embodiment of the material application system, it is provided that the first fluid supply unit is coupled to the material supply unit, in particular to a material supply line between the material supply unit and the nozzle device. It is particularly preferred that a compressed air valve is arranged between the first fluid supply unit and the material supply unit, in particular the material supply line, in order to control a first fluid flow to the material supply unit. It is preferred that the material application system has one, two or more fluid flow controllers that are configured for mass flow and/or volume flow control of the fluid flow and/or further fluid flows.

A further preferred embodiment of the material application system is characterized by the fact that it comprises an admixture supply unit, in particular an accelerator supply unit, which is coupled to the nozzle device in such a way that an admixture, in particular an accelerator, can be supplied to the material, in particular to the concrete, in particular within the nozzle device. The admixture supply unit is set up in particular in such a way that an admixture, in particular an accelerator, is supplied under volume flow control. The admixture supply unit preferably comprises a low-pulsation screw pump for metering the admixture, in particular the accelerator.

A further preferred embodiment of the material application system comprises a second fluid supply unit, in particular a water supply unit, which is coupled, in particular fluidically coupled, to the nozzle unit, the nozzle device, the material supply unit, the first fluid supply unit and/or the admixture supply unit in order to supply a second fluid, in particular water, thereto. The second fluid can also be used, for example, by the cleaning unit and/or the cleaning device for cleaning the nozzle device.

In a further preferred embodiment of the material application system, it is provided that one or the control device comprises a memory unit in which a material model is stored which maps relationships between geometry, in particular material layer height, material layer width and material layer shape, and/or material consistency of the applied material layer as a function of process parameters, in particular pressures, volume flows, nozzle spacings and/or feed rates, in order to adapt the process parameters in a defined manner during the running process in such a way that continuously changeable geometries of the applied material layer or material properties result.

Furthermore, it may be preferred that the control device is set up to automatically generate a material model described in the foregoing by automatically adjusting the process parameters and automatically detecting the resulting geometry and material consistency. It is particularly preferred that machine learning methods, for example neural networks, are used to generate the material model.

Furthermore, it may be preferred that the control device is arranged to control and/or regulate a movement of the nozzle element such that the cleaning device with the cleaning section is inserted into the nozzle element. It is further preferred that the control device controls a fluid flow through the cleaning device into the nozzle element. The fluid flow is preferably provided by a fluid pump.

According to a further aspect, the above-mentioned objective is solved by a manufacturing system comprising a material application system according to one of the embodiments described above and/or a nozzle device according to one of the embodiments described above, and a first handling unit for moving the nozzle device in order to apply, in particular spray, a material, in particular concrete, and/or a second handling unit for handling the nozzle element, in particular for replacing the nozzle element.

The first handling unit and/or the second handling unit can or may be designed, for example, as a robot, in particular as an articulated-arm robot. The second handling unit may furthermore be designed as or comprise a mechanical holder.

According to a further aspect, the aforementioned objective is solved by a method for producing a three-dimensional component from a material, in particular a shotcrete component made of concrete, comprising the step of: applying, in particular spraying, the material, in particular the concrete, with a first nozzle element arranged on a nozzle unit.

It is preferred that the nozzle element is replaceably arranged on the nozzle unit and the method comprises the steps: removing the first nozzle element and arranging a second nozzle element, and applying, in particular spraying, the material, in particular the concrete, with the second nozzle element arranged replaceably on the nozzle unit.

According to a preferred embodiment of the method, it is provided that it comprises the step of: cleaning the first nozzle element and/or the second nozzle element while it is or they are arranged on the nozzle unit and/or while it is or they are stored in a nozzle element rest. Further, the method may comprise the step of: cleaning the nozzle unit.

Cleaning is preferably performed with a fluid and/or with a cleaning element. Furthermore, it is preferred that cleaning takes place in predefined cleaning cycles and/or when a blockage is detected.

Furthermore, it is preferred that the method comprises the step of: detecting a spacing between the nozzle unit and a material layer applied with the nozzle unit, and/or detecting dimensions of the material layer applied with the nozzle unit.

Furthermore, it may be preferred that the method comprises the step of: automatically adding lubricant and/or a cement slurry to the material application system when starting the system to ensure pumpability of the concrete. Further, the method may comprise the step of: pressure-based detection of the lubricant in the material application system to pump it until the first batch of concrete reaches the nozzle device. In addition, detection of the lubricant may be accomplished by conductive or other point level sensing. It may be further preferred that the or a point level sensor system is used to detect the concrete and/or cleaning condition in the material delivery system.

Furthermore, the method may comprise the step of: opening a concrete and/or an accelerator valve when starting the nozzle device after reaching a defined target pressure to ensure an accelerator effect and/or so that the accelerator content does not exceed a threshold value above which, for example, the material guide or the nozzle element clogs.

In addition, the process may comprise the step of: sequence-controlled nozzle element start, in which the accelerator is added only after a predefined time and after the addition of concrete and compressed air to prevent nozzle clogging. This prevents the accelerator from solidifying the concrete within the nozzle element and/or nozzle unit when starting the process, rendering the nozzle element unusable.

In addition, the method may comprise the step of: sequence-controlled nozzle element stop, in which the accelerator addition is terminated and the addition of concrete and compressed air is terminated after a predefined time after termination of the accelerator addition. The sequence-controlled nozzle element stop has the advantage that no or little accelerator is present in the nozzle element and/or nozzle unit when the process is terminated, thus avoiding rapid solidification of concrete.

The method and its possible further developments have features or method steps which make them particularly suitable for being used for a nozzle device and/or a material application system and/or a manufacturing system and their further developments. For further advantages, embodiment variants and embodiment details of the further aspects and their possible further embodiments, reference is also made to the previously given description concerning the corresponding features and further embodiments of the nozzle device.

Preferred embodiments are explained by way of example with reference to the accompanying figures. They show:

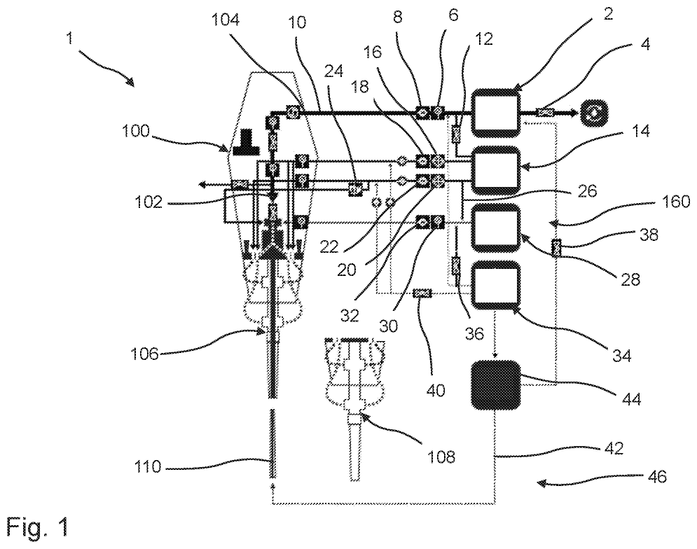

FIG. 1: a schematic, two-dimensional view of an exemplary embodiment of a material application system;

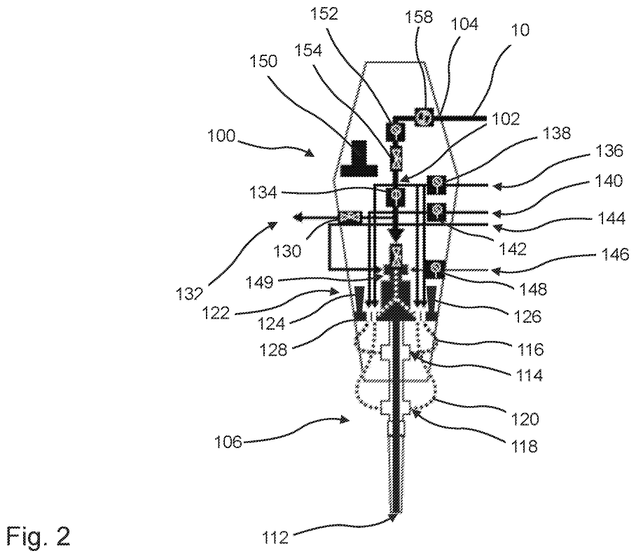

FIG. 2: a schematic, two-dimensional detailed view of an exemplary embodiment of a nozzle device;

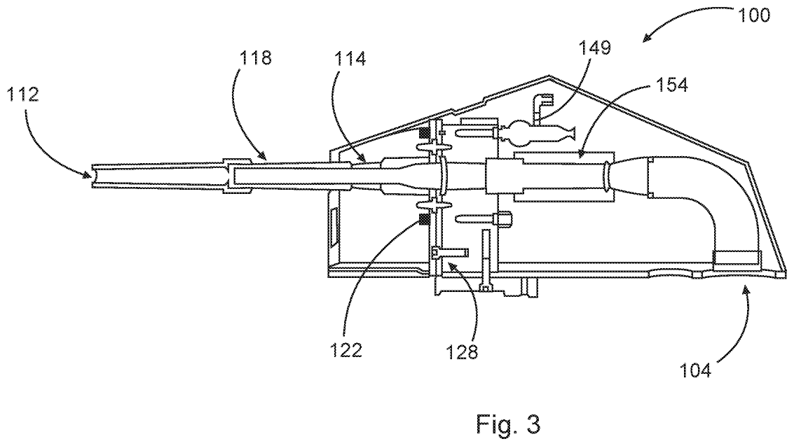

FIG. 3: a further schematic, two-dimensional detailed view of an exemplary embodiment of a nozzle device;

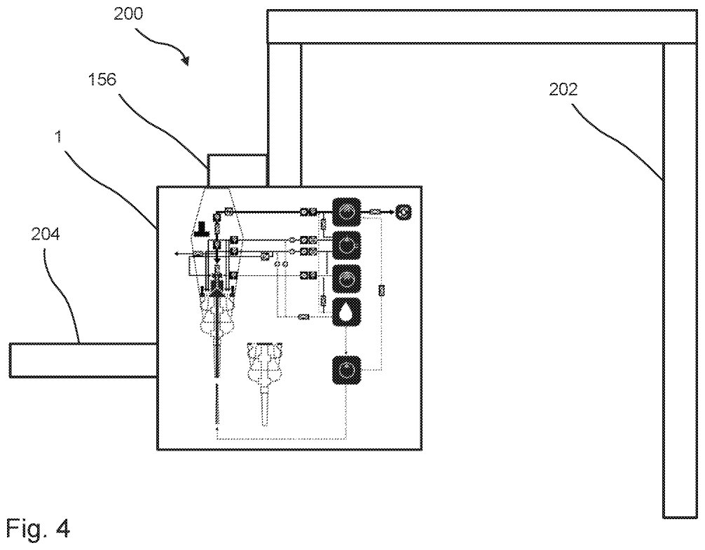

FIG. 4: a schematic, two-dimensional view of an exemplary embodiment of a manufacturing system; and

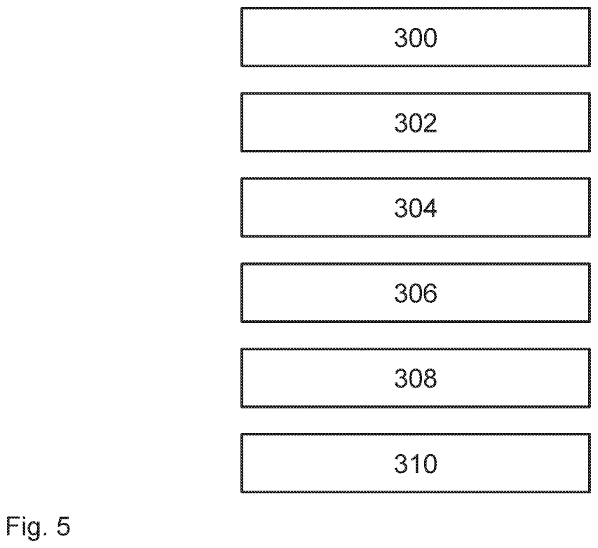

FIG. 5: a schematic procedure.

In the figures, identical or essentially functionally identical or similar elements are designated with the same reference signs.

FIG. 1 shows a material application system 1. The material application system 1 comprises a nozzle device 100, a concrete supply unit 2, a first fluid supply unit, which is designed as a compressed air supply unit 14, an accelerator supply unit 28 and a second fluid supply unit, which is designed as a water supply unit 34. The concrete supply unit 2, the compressed air supply unit 14 and the accelerator supply unit 28 are connected to the nozzle device 100 by means of lines, in particular fluidically coupled.

The concrete supply unit 2 is fluidically coupled to the material line 10 with the nozzle device 100. A first concrete pressure sensor 6 and a concrete volume flow sensor 8 act within the material line 10. Furthermore, the concrete supply unit 2 is coupled to a waste water unit 4, wherein the waste water unit 4 comprises a pinch valve.

The compressed air supply unit 14 is coupled to the nozzle device 100 by means of compressed air lines, two compressed air lines leading from the compressed air supply unit 14 to the nozzle device 100. A first compressed air line comprises a first temperature control unit 16 and a first mass flow controller 18. By means of the first temperature control unit 16, the temperature of the compressed air provided can be controlled or set. By means of the first mass flow controller 18, a mass flow of the compressed air provided can be adjusted.

Analogous to the first compressed air line, a second compressed air line comprises a second temperature control unit 20 and a second mass flow controller 22. Furthermore, a pressure regulator 24 is provided between the second mass flow controller 22 and the nozzle device 100 for withdrawing a pressure-controlled compressed air, the outgoing line likewise leading into the nozzle device 100 and, in particular, being fluidically coupled to the two-substance nozzle 149 for atomizing the accelerator. In addition, a fluidic connection between the compressed air supply unit 14 and the material line 10 can be established by means of a compressed air valve 12 and between the compressed air supply unit 14 and the accelerator supply unit 28 can be established by means of a compressed air valve 26, wherein the compressed air can be used to clean the lines with compressed air.

The accelerator supply unit 28 is also coupled to the nozzle device 100 via a line. An accelerator pressure sensor 30 and an accelerator volume flow sensor 32 are provided within this line.

The water supply unit 34 is fluidically coupled to the concrete supply unit 2 and the accelerator supply unit 28 to enable cleaning of the lines with water. Water valves 36-40 are provided for this purpose. The material application system 1 further comprises a cleaning device 46 with a cleaning lance 110. The cleaning lance 110 is insertable into the nozzle element with a cleaning section. Furthermore, a high pressure line 42 extends from the water supply unit 34, by means of which a nozzle element 106 can be cleaned in combination with the cleaning lance 110 and a high pressure pump 44. For example, the water supply unit 34 may provide a fluid that exits from a cleaning opening of the cleaning lance 110.

Furthermore, the nozzle device 100 comprises a cleaning unit 160, which is arranged to clean the nozzle unit 101 and/or the nozzle element 106, in particular with a pressurized fluid, preferably water, and/or a cleaning element, in particular a cleaning pig.

FIGS. 2 and 3 show a detailed view of the nozzle device 100. Concrete reaches the material inlet 104 via the material line 10. The material inlet 104 is coupled to a material guide 102, which in particular extends from the material inlet 104 towards the nozzle element 106. Downstream of the material inlet 104, a viscosity sensor 158 is arranged to measure the consistency, in particular the viscosity, of the material, in this case concrete.

Furthermore, the nozzle device 100 comprises a first compressed air inlet 136 with a first pressure sensor 138 and a second compressed air inlet 140 with a second pressure sensor 142. Furthermore, the nozzle device 100 comprises a third compressed air inlet 144 for the compressed air tapped at the pressure regulator 24, which is fluidically coupled to the two-substance nozzle 149. Further, the nozzle device 100 includes an accelerator inlet 146 having an accelerator pressure sensor 148 fluidly coupled to the two-substance nozzle 149. In the two-substance nozzle 149, the accelerator is atomized with the supplied compressed air.

The material guide 102 is arranged such that the material, in particular concrete, can be moved from the material inlet 104 to the nozzle element 106. A second concrete pressure sensor 152 is further provided within the material guide 102, as well as a material flow control unit 154 that can act as a concrete valve. A concrete flow can be started or stopped by actuating the material flow control unit 154.

Downstream of the material flow control unit 154, a temperature sensor 134 is provided. The temperature sensor 134 preferably sends a temperature signal to a control device 156, which in turn controls the first temperature control unit 16 and/or the second temperature control unit 20 to control a temperature of the concrete. Further downstream, the concrete enters the nozzle element 106, which includes a first concrete atomization unit 114 and a second concrete atomization unit 118. In the first concrete atomization unit 114, the concrete is mixed with a compressed air. The compressed air is provided to the first concrete atomization unit 114 by means of a compressed air supply line 116 coupled to one of the compressed air inlets 136, 140. In the second concrete atomization unit 118, the concrete is further mixed with additional compressed air and an atomized accelerator. The compressed air and atomized accelerator are provided to the second concrete atomization unit 118 by means of the compressed air and accelerator supply line 120. The compressed air for the second concrete atomization unit is preferably provided at the compressed air inlet 136, 140 that is not fluidly coupled to the first concrete atomization unit 114. Compressed air and accelerator supply line 120 is further fluidly coupled to two-substance nozzle 149.

For cleaning the nozzle device 100, it is provided with a blow-out unit 130 having a blow-out 132, for example a blow-out opening.

The nozzle device 100 further comprises a sensor unit 122. The sensor unit 122 comprises a radar module 124 and a profile sensor module 126. The radar module 124 is preferably arranged to detect a distance between the nozzle device 100 and a material layer applied with the nozzle device 100. The profile sensor module 126 is particularly configured to detect dimensions of a layer of material applied with the nozzle device 100.

The nozzle device 100 further includes a nozzle element interface 128 arranged and configured to form a connection of the nozzle unit 101 to the nozzle element 106.

The nozzle element 106 preferably extends from the distal spray end 112 to a proximal material inlet end. A cavity preferably extends from the material inlet end to the spray end 112. Within the cavity, concrete may pass from the material inlet end toward the spray end 112. The material inlet end faces the nozzle unit 101 in intended operation. The spray end 112 faces away from the nozzle unit 101 in intended operation. The cross-section of the nozzle element adjacent to the spray end 112 may, for example, have a dimension of 3 mm to 48 mm.

The nozzle element 106 is replaceably arranged on the nozzle unit 101. The nozzle element interface 120 is set up in such a way that the nozzle element 106 can be automatically removed from the nozzle unit 101 and arranged again on the nozzle unit 101.

The nozzle device 100 further comprises an ultrasonic unit 150. The ultrasonic unit 150 is arranged to introduce vibrations into the nozzle unit 101 and/or nozzle device 100 and/or into the nozzle element 106. The ultrasonic vibrations improve the spray quality.

FIG. 4 shows a manufacturing system 200 with a first handling unit 202 and a second handling unit 204. A material application system 1 is arranged on the first handling unit 202. In particular, it is preferred that only the nozzle device 100 is moved by the first handling unit and the other components of the material application system 1 are arranged statically and coupled to the nozzle device 100, for example, by means of elastic lines. In particular, the second handling unit 204 of the manufacturing system 200 is arranged and configured to remove the nozzle element 106 from the nozzle unit 101 and to arrange a second nozzle element 108 on the nozzle unit 101.

With the material application system 1 and/or with the manufacturing system 200 and/or with the nozzle device 100, a process for producing a three-dimensional component made of a material, in particular a shotcrete component made of concrete, can be realized in an advantageous manner. In particular, these components enable a fully automated process with independent error handling, which reduces the manual effort and can thus be operated by only one person. Furthermore, the manufacturing system 200, the material application system 1 and/or the nozzle device 100 reduces scrap and rework due to a higher process quality.

Furthermore, a higher accuracy between CAD planning and production process is enabled, which reduces the development efforts for new components. Furthermore, the manufacturing system 200, the material application system 1 and/or the nozzle device 100 can be used flexibly, since the system can be used in cold and also in hot regions due to the temperature compensation. Furthermore, the manufacturing system 200, the material application system 1 and the nozzle device 100 enable new use cases for the production of three-dimensional concrete components, namely by adjusting the application geometry during the ongoing process.

FIG. 5 shows a method for producing a three-dimensional component made of a material, in particular a shotcrete component made of concrete. In step 300, a material is applied, in particular sprayed, which may be concrete, for example. The application is performed with a first nozzle element 106 replaceably arranged on a nozzle unit 101. In step 302, the first nozzle element 106 is removed and a second nozzle element 108 is arranged. In step 304, a material is applied, in particular sprayed, with the second nozzle element 108 replaceably arranged on the nozzle unit 101. In step 306, the first nozzle element 106 and/or the second nozzle element 108 is/are cleaned while arranged on the nozzle unit 106. In addition, cleaning may also be performed while they are stored in a nozzle element rest.

In step 308, a detection of a spacing between the nozzle unit 101 and a material layer applied with the nozzle unit 101 is performed. In step 310, the dimensions of the material layer applied with the nozzle unit 101 are detected.

### REFERENCE SIGNS

1 Material application system

2 Concrete supply unit

4 Wastewater unit with pinch valve

6 first concrete pressure sensor

8 Concrete volume flow sensor

10 Material line

12 Compressed air valve

14 Compressed air supply unit

16 First temperature control unit

18 First mass flow controller

20 Second temperature control unit

22 Second mass flow controller

24 Pressure regulator

26 Air valve

28 Accelerator supply unit

30 Accelerator pressure sensor

32 Accelerator volume flow sensor

34 Water supply unit

36 First water valve

38 Second water valve

40 Third water valve

42 High pressure line

44 High pressure pump

46 Cleaning device

100 Nozzle device

101 Nozzle unit

102 Material guide

104 Material inlet

106 Nozzle element

108 Second nozzle element

110 Cleaning lance

112 Spray end

114 Concrete atomization unit

116 Compressed air supply line

118 Second concrete atomization unit

120 Compressed air and accelerator supply line

122 Sensor unit

126 Profile sensor module

128 Nozzle element interface

130 Blow-out unit

132 Blow-out

134 Temperature sensor

136 First compressed air inlet

138 First pressure sensor

140 Second compressed air inlet

142 Second pressure sensor

144 Third compressed air inlet

146 Accelerator inlet

148 Accelerator pressure sensor

149 Two-substance nozzle

150 Ultrasonic unit

152 Second concrete pressure sensor

154 Material flow control unit

156 Control device

158 Viscosity sensor

160 Cleaning unit

200 Manufacturing system

202 First handling unit

204 Second handling unit

1. A nozzle device for producing a three-dimensional shotcrete component made of a concrete material, comprising
a nozzle unit with a material guide, having a material inlet for introducing the concrete material, and
a nozzle element fluidically coupled to the material inlet for applying the concrete material, which is replaceably arranged on the nozzle unit.

2. The nozzle device according to claim 1, comprising
a nozzle element interface arranged and configured to form a connection of the nozzle unit to the nozzle element, and
wherein the nozzle element interface comprises a material interface, a first compressed air interface, a second compressed air interface, and/or an accelerator interface.

3. The nozzle device according to claim 1, comprising
a cleaning unit, which is configured to clean the nozzle unit and/or the nozzle element, with a pressurized fluid and/or a cleaning element.

4. The nozzle device according to claim 1, comprising
a blow-out unit for cleaning the nozzle device, and
wherein the blow-out unit and the nozzle unit are configured such that material components not usable by the nozzle unit are disposed of by the blow-out unit.

5. The nozzle device according to claim 1, comprising
a material flow control unit acting within the material guide for controlling a concrete material flow, which is configured as a pinch valve, and/or
a concrete material pressure sensor within the material guide.

6. The nozzle device according to claim 1, comprising:
a sensor unit for geometry correction,
wherein the sensor unit comprises at least one radar module or is formed as a radar module, and the radar module is configured to detect a spacing between the nozzle device and a concrete material layer applied with the nozzle device, and/or
wherein the sensor unit comprises at least one profile sensor module for detecting dimensions of a concrete material layer applied with the nozzle device or is configured as a profile sensor module for detecting dimensions of the concrete material layer applied with the nozzle device.

7. The nozzle device according claim 1, comprising
a vibration unit for introducing vibrations, which is configured to introduce the vibrations into the nozzle unit and/or nozzle device.

8. The nozzle device according to claim 1, comprising a control device arranged and configured to
receive a distance signal characterizing a distance between the nozzle element and a generated concrete material layer from the sensor unit, and/or receive a size signal characterizing a dimension of the generated concrete material layer, and generate a control signal for controlling a handling unit guiding the nozzle unit based on the distance signal and/or the size signal, and/or
receive a consistency signal characterizing a material consistency of the concrete material and generate and transmit a consistency correction signal, and/or
receive a clogging signal characterizing a clogging or detect a clogging and cause a cleaning with a cleaning signal, by a cleaning unit, and/or generate a replacement signal causing a handling unit to replace the nozzle element, and/or
initiate and/or terminate a concrete material application by controlling a material flow control unit.

9. The nozzle device according to claim 1, comprising
a first concrete atomization unit arranged and configured to mix and/or atomize the concrete material with air, and/or
a second concrete atomization unit arranged and configured to mix and/or atomize the concrete material with air and an accelerator,
wherein the nozzle element comprises the first concrete atomization unit and/or the second concrete atomization unit.

10. The nozzle device according to claim 9, comprising
a first compressed air input coupled to a first pressure sensor, and/or
a second compressed air input coupled to a second pressure sensor,
wherein the first pressure sensor is coupled to the first concrete atomization unit and/or the second pressure sensor is coupled to the second concrete atomization unit.

11. The nozzle device according to claim 9, comprising
a two-substance nozzle for atomizing the accelerator with compressed air, and
a broaching unit, comprising a needle valve, arranged and configured to clean the two-substance nozzle by broaching material, wherein the broaching unit comprises a broach for movement into the two-substance nozzle,
wherein the two-substance nozzle is arranged upstream of the first concrete atomization unit and/or upstream of the second concrete atomization unit in a concrete material flow direction.

12. The nozzle device according to claim 1, comprising
a temperature sensor for determining the temperature of the concrete material, the temperature sensor being arranged within the material guide, and/or
a temperature control unit for tempering the concrete material, by heating and/or cooling a compressed air to be supplied to the concrete material.

13. A material application system for producing a three-dimensional shotcrete component made of a concrete material, comprising
a nozzle device, comprising
a nozzle unit with a material guide, having a material inlet for introducing the concrete material, and
a nozzle element fluidically coupled to the material inlet for applying the concrete material, which is replaceably arranged on the nozzle unit,
wherein the nozzle device is coupled to a concrete material supply unit configured to provide the concrete material to the nozzle unit.

14. The material application system according to claim 13, comprising a cleaning device configured to clean the nozzle element, wherein the cleaning device comprises or is configured as a fluid-carrying cleaning lance.

15. The material application system according to claim 13, comprising
a first fluid supply unit which is coupled to the nozzle device and configured to supply a first fluid to the nozzle device.

16. The material application system according to claim 15, wherein
the first fluid supply unit is coupled to the concrete material supply unit via a material supply line between the concrete material supply unit and the nozzle device, and
a compressed air valve is arranged between the first fluid supply unit and the material supply line to control flow of the first fluid flow to the material supply unit.

17. The material application system according claim 13, comprising
an admixture supply unit which is coupled to the nozzle device such that an admixture is suppliable to the concrete material within the nozzle device.

18. The material application system according to claim 17, comprising
a second fluid supply unit which is coupled to the nozzle unit, the nozzle device, the material supply unit, the first fluid supply unit and/or the admixture supply unit to supply a second fluid thereto.

19. A manufacturing system, comprising
the material application system according to claim 13, and
a first handling unit for moving the nozzle device to apply the concrete material, and/or
a second handling unit for handling and replacing the nozzle element.

20. A method of manufacturing a three-dimensional shotcrete component made of a concrete material, comprising the steps of:
providing a nozzle device comprising a nozzle unit with a material guide, having a material inlet for introducing the concrete material, and a nozzle element fluidically coupled to the material inlet for applying the concrete material, wherein the nozzle element is replaceably arranged on the nozzle unit, and
spraying the concrete material with a first nozzle element arranged on the nozzle unit.

21. The method according to of the preceding claim 20, wherein the first nozzle element is replaceably disposed on the nozzle unit, the method comprising the steps of:
removing the first nozzle element and arranging a second nozzle element on the nozzle unit, and
spraying the concrete material with the second nozzle element replaceably arranged on the nozzle unit.

22. The method according to claim 21, comprising the step of:
cleaning the first nozzle element and/or the second nozzle element while it is or they are arranged on the nozzle unit and/or while it is or they are stored in a nozzle element rest,
wherein the cleaning is performed with a fluid, with a cleaning element and/or with a cleaning device, and/or
wherein the cleaning is performed in predefined cleaning cycles and/or when a blockage is detected.

23. The method according to claim 20, comprising the step of:
detecting a spacing between the nozzle device and a concrete material layer applied with the nozzle device, and/or
detection of dimensions of the concrete material layer applied by the nozzle device.
